(19) United States
(12) Patent Application Publication
(10) Pub. No.: US 2013/0144937 A1
(43) Pub. Date: Jun. 6, 2013

(54) APPARATUS AND METHOD FOR SHARING USER'S EMOTION

(71) Applicant: Ho-Sub Lee, Seoul (KR)

(72) Inventor: Ho-Sub Lee, Seoul (KR)

(73) Assignee: Samsung Electronics Co., Ltd., Suwon-si (KR)

(21) Appl. No.: 13/569,089

(22) Filed: Aug. 7, 2012

(30) Foreign Application Priority Data
Dec. 2, 2011 (KR) 10-2011-0128593

(51) Int. Cl. G06F 15/16

(52) U.S. Cl. 709/203; 709/224

(57) ABSTRACT

An emotion sharing apparatus includes an emotion classification unit configured to classify a recognized emotional state of a user of a terminal into one of at least two kinds of emotional states; an emotion analysis unit configured to calculate an emotion rate defined based on a ratio of one kind of emotional state of the at least two kinds of emotional states to another kind of emotional state of the at least two kinds of emotional states; a change-in-emotion rate calculator configured to calculate a change in the emotion rate; and a transmitter configured to transmit the change in the emotion rate to another terminal.

### CROSS-REFERENCE TO RELATED APPLICATIONS

This application claims the benefit under 35 USC 119(a) of Korean Patent Application No. 10-2011-0128593 filed on Dec. 2, 2011, in the Korean Intellectual Property Office, the disclosure of which is incorporated herein by reference in its entirety for all purposes.

### BACKGROUND

1. Field

The following description relates to a technique of recognizing and sharing a user's emotion.

2. Description of the Related Art

Recently, a Social Network Service (SNS), such as Facebook, Twitter, Google+, etc., is attaining great popularity throughout the world. SNS is a web service capable of helping build a wide human network including new personal connections, as well as making good connections with acquaintances, such as friends and coworkers, on the Internet. Recently, most SNS providers offer a client application for a smart phone so that users can use the SNS anywhere and anytime using the smart phone.

The results of recent studies in brain science and psychology fields support that the proposition that emotion has a greater influence on the human thinking process than reason (i.e., intellect). Specifically, it was found that a time taken for the emotional brain to process sensed information is only one-fifth of a time taken for the rational brain to process the same sensed information. Thus, a human feels emotion in response to a certain stimulus, etc., prior to making a rational thinking or determination in response to the stimulus.

That is, a human's emotional state is reflected in his or her desires, decisions, expressions, etc.

With the popularization of SNS, many users are sharing their daily lives or thoughts with their acquaintances by posting writings through SNS, and the writings may contain their emotional states. Practically, users express their emotions directly/indirectly using various emoticons, etc., and their acquaintances react to them by leaving replies, etc., while assimilating the users' emotional states in some cases. For example, when a certain user expresses a positive emotional state, his or her acquaintances may react to the positive emotional state also entering a positive emotional state. The psychological term for this phenomenon is “Emotional Contagion,” and according to the results of recent studies, the process of such Emotional Contagion has been observed through an experiment on Facebook, which is a representative SNS.

As such, communications between users through SNS may contain a user's emotion, which triggers interactions (for example, leaving a reply, calling, meeting, etc.) between the users to thereby induce a positive or negative emotional state in the users. Accordingly, controlling such a process will contribute to minimization of users' negative emotional states or to maximization of users' positive emotional states. However, in many cases, users do not properly express their emotional states, and actual interactions between users tend to occur manually or accidently even though their emotional states are expressed automatically by various emotion recognition technologies. Therefore, controlling interactions between users is very difficult.

### SUMMARY

According to an aspect, an emotion sharing apparatus includes an emotion classification unit configured to classify a recognized emotional state of a user of a terminal into one of at least two kinds of emotional states; an emotion analysis unit configured to calculate an emotion rate defined based on a ratio of one kind of emotional state of the at least two kinds of emotional states to another kind of emotional state of the at least two kinds of emotional states; a change-in-emotion rate calculator configured to calculate a change in the emotion rate; and a transmitter configured to transmit the change in the emotion rate to another terminal.

The at least two kinds of emotional states may include a positive emotional state and a negative emotional state.

The emotion analysis unit may be further configured to calculate the emotion rate based on a ratio of the positive emotional state to the negative emotional state.

The emotion analysis unit may be further configured to calculate a total emotion rate and a recent emotion rate according to a use time of the terminal of the user.

The change-in-emotion rate calculator may be further configured to calculate the change in the emotion rate based on a difference between the recent emotion rate and the total emotion rate.

The change-in-emotion rate calculator may be further configured to allocate a weight to the change in the emotion rate in consideration of a tendency of the user.

According to an aspect, an emotion sharing apparatus includes a receiver configured to receive a change in an emotion rate for each of a plurality of users from a plurality of terminals respectively used by the users; a first extractor configured to extract an emotion transmitting terminal from the plurality of terminals based on the change in the emotion rate for each of the users; a second extractor configured to extract at least one emotion receiving terminal from at least one terminal registered in the emotion transmitting terminal; and an emotion provider configured to transmit information about an emotional state of the user of the emotion transmitting terminal to the at least one emotion receiving terminal.

An emotion of the user may be classified into one of at least two kinds of emotional states; and the change in the emotion rate may be defined based on a ratio of one kind of emotional state of the at least two kinds of emotional states to another kind of emotional state of the at least two kinds of emotional states.

An emotion rate of the user may be represented as a ratio of a positive emotional state to a negative emotional state; and the change in the emotion rate may include at least one of a change in an emotion rate regarding the positive emotional state and a change in an emotion rate regarding the negative emotional state.

The first extractor may be further configured to extract, as the emotion transmitting terminal, a terminal of a user having a change in an emotion rate that exceeds a predetermined threshold value.

The emotion sharing apparatus may further include a threshold value update unit configured to update the predetermined threshold value according to a change in an emotion rate received by the receiver after the emotional state of the user has been transmitted to the at least one emotion receiving terminal by the emotion provider.

The second extractor may be further configured to extract, as the at least one emotion receiving terminal, at least one terminal in a predetermined sharing range in the at least one terminal registered in the emotion transmitting terminal.

The predetermined sharing range may be determined by a current location of the emotion transmitting terminal or a contact frequency stored in the emotion transmitting terminal, or is set by the user of the emotion transmitting terminal.

The emotion provider may be further configured to query the emotion transmitting terminal about whether or not to provide the emotional state of the user to the at least one emotion receiving terminal before transmitting the emotional state of the user to the at least one emotion receiving terminal.

According to an aspect, an emotion sharing system includes a plurality of client terminals each configured to classify a recognized emotional state of a user of the client terminal into a positive emotional state and a negative emotional state; calculate an emotion rate defined based on a ratio of the positive emotional state to the negative emotional state; calculate a change in the emotion rate; and transmit the change in the emotion rate to other ones of the client terminals; and a server terminal configured to receive a change in an emotion rate for each user of the plurality of client terminals from the plurality of client terminals; extract an emotion transmitting terminal from the plurality of client terminals based on the change in the emotion rate for each user; extract at least one emotion receiving terminal from at least one client terminal registered in the emotion transmitting terminal; and transmit information about an emotional state of the user of the emotion transmitting terminal to the at least one emotion receiving terminal.

According to an aspect, an emotion sharing method includes classifying a recognized emotional state of a user of a terminal into one of at least two kinds of emotional states; calculating an emotion rate defined based on a ratio of one kind of emotional state of the at least two kinds of emotional states to another kind of emotional state of the at least two kinds of emotional states; calculating a change in the emotion rate; and transmitting the change in the emotion rate to another terminal.

According to an aspect, a non-transitory computer-readable storage medium stores instructions for controlling a processor to perform the emotion sharing method described above.

According to an aspect, an emotion sharing method includes receiving a change in an emotion rate for each user of a plurality of users from a plurality of terminals respectively used by the users; extracting an emotion transmitting terminal from the plurality of terminals based on the change in the emotion rate for each of the users; extracting at least one emotion receiving terminal from at least one terminal registered in the emotion transmitting terminal; and transmitting information about an emotional state of the user of the emotion transmitting terminal to the at least one emotion receiving terminal.

According to an aspect, a non-transitory computer-readable storage medium stores instructions for controlling a processor to perform the emotion sharing method described above.

According to an aspect, an emotion sharing apparatus includes an emotion classification unit configured to classify recognized emotional states of a user of a terminal into a plurality of kinds of emotional states; an emotion analysis unit configured to calculate an emotion rate based on a ratio of a number of the emotional states that have been classified into a first kind of the plurality of kinds of emotional states to a number of the emotional states that have been classified into a second kind of the plurality of kinds of emotional states; a change-in-emotion rate calculator configured to calculate a change in the emotion rate; and an emotion provider configured to transmit the change in the emotion rate to another terminal used by another user.

The emotion analysis unit may be further configured to calculate a total emotion rate for a total period of time from a beginning of emotion recognition for the user to a current time; and a recent emotion rate for a specific period of time ending at the current time.

The change-in-emotion rate calculator may be further configured to calculate the change in the emotion rate based on a difference between recent emotion rate and the total emotion rate.

The change-in-emotion rate calculator may be further configured to calculate a first change in emotion rate for the first kind of emotional state based on the difference between the recent emotion rate and the total emotion rate; and a second change in emotion rate for the second kind of emotional state based on the difference between the recent emotion rate and the total emotion rate.

The change-in-emotion rate calculator may be further configured to multiply the first change in emotion rate by a first weight to obtain a first weighted change in emotion rate; and multiply the second change in emotion rate by a second weight to obtain a second weighted change in emotion rate; and the emotion provider may be further configured to transmit the first weighted change in emotion rate and the second weighted change in emotion rate to the other terminal.

Other features and aspects will be apparent from the following detailed description, the drawings, and the claims.

### BRIEF DESCRIPTION OF THE DRAWINGS

FIG. 1 illustrates an example of an emotion sharing system.

FIG. 2 is a diagram illustrating an example of a terminal that may be a client terminal.

FIG. 3 is a table for explaining an example of an emotion classification method.

FIG. 4 is a table for explaining an emotion analysis method and a method of obtaining a change in emotion rate.

FIG. 5 is a diagram illustrating an example of a terminal that may be a server terminal.

FIG. 6 is a view for explaining an example of a method of providing an emotional state.

FIG. 7 is a flowchart illustrating an example of an emotion sharing method.

FIG. 8 is a flowchart illustrating an example of an emotion sharing method.

### DETAILED DESCRIPTION

The following description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. Also, descriptions of well-known functions and constructions may be omitted for increased clarity and conciseness.

Throughout the drawings and the detailed description, the same reference numerals refer to the same elements. The relative size and depiction of these elements may be exaggerated for clarity, illustration, and convenience.

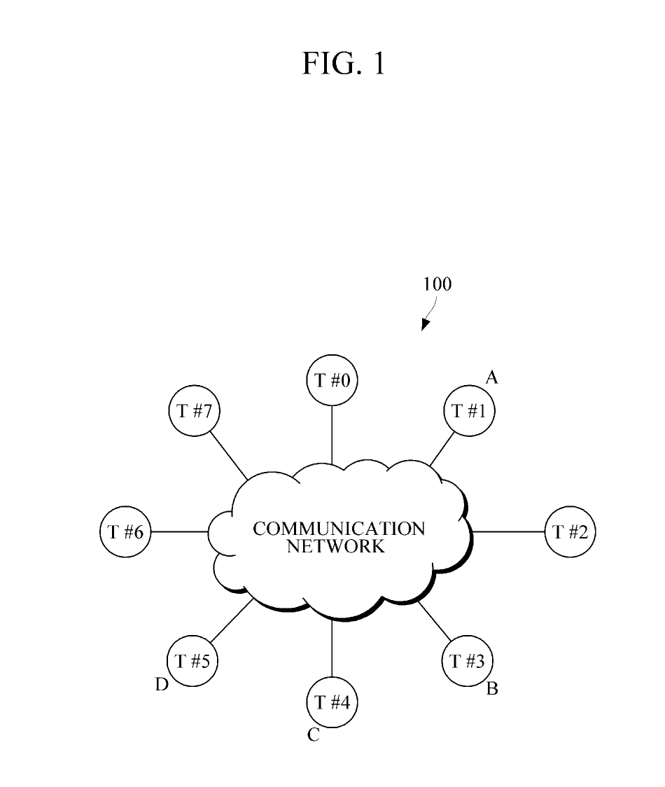

FIG. 1 illustrates an example of an emotion sharing system 100. Referring to FIG. 1, the emotion sharing system 100 includes a plurality of terminals T#0 through T#7 that are connected to each other through a communication network.

Each terminal T#0 through T#7 may be a device that provides a communication function. For example, each terminal T#0 through T#7 may be a smart phone that supports a messenger service. However, the smart phone is only an example, and each terminal T#0 through T#7 may be any kind of mobile terminal, such as a mobile phone, a tablet PC, or the like, or any kind of fixed terminal, such as a personal computer, a television, a game system, etc.

Each terminal T#0 through T#7 recognizes a user's emotion. For example, each terminal T#0 through T#7 may acquire a user's face image through a camera mounted thereon and analyze the user's face image to thereby recognize the user's emotion. In the current example, the user's emotion may be recognized by various methods. For example, the user's emotion may be recognized by the user's voice, the user's text message, the kind of an application being currently executed, the location of the user, etc., as well as by the user's face image. Various techniques for recognizing a user's emotion are well known to one of ordinary skill in the art, and thus will not be described in detail here.

One of the terminals T#0 through T#7 may function as a server while also recognizing a user's emotion. For convenience of description, it will be assumed that the terminal T#0 is a server terminal functioning as a server.

When the terminals T#0 through T#7 have recognized the corresponding users' emotions, the server terminal T#0 receives emotion information regarding the respective users' emotions from the terminals #0 through T#7, with the server terminal T#0 functioning as both a server and a client.

Then, the server terminal T#0 analyzes the received emotion information to thus detect a terminal of a user who is in a specific emotional state. For example, it will assumed that the server terminal T#0 detects a user who is in a very gloomy mood. If a user A is in a very gloomy mood, the server terminal T#0 detects the terminal T#1, which is the user A's terminal, as an “emotion transmitting terminal”. The user A's emotion may be shared by other users through the emotion transmitting terminal.

Also, the server terminal T#0 extracts all or a part of other terminals registered in the emotion transmitting terminal T#1. For example, it is assumed that users B, C, and D of the terminals T#3, T#4, and T#5, respectively, are the user A's acquaintances. In this case, the terminals T#3, T#4, and T#5 are registered in the terminal T#1. Then, the server terminal T#0 extracts the terminals T#3, T#4, and T#5 registered in the terminal T#1 as “emotion receiving terminals”. The emotion receiving terminals T#3, T#4, and T#5 receive the user A's emotion from the emotion transmitting terminal T#1.

That is, the server terminal T#0 transmits the emotional state of the user A of the emotion transmitting terminal T#1 to the emotion receiving terminals. For example, the server terminal T#0 transmits the emotional state of the user A of the terminal T#1 that is an emotion transmitting terminal to the terminals T#3, T#4, and T#5 that are emotion receiving terminals.

Accordingly, the users B, C, and D who are the user A's acquaintances may be informed of the user A's emotional state, and the users B, C, and D who have recognized the user A's emotional state may contact the user A to help the user A recover from his or her gloomy mood.

Also, unlike the example of FIG. 1, it is possible that a plurality of user terminals may be detected as emotion transmitting terminals, and that some terminals may be grouped together and managed as a group. For example, if the users C and D belong to the same family, the terminals T#4 and T#5 may be managed as a group.

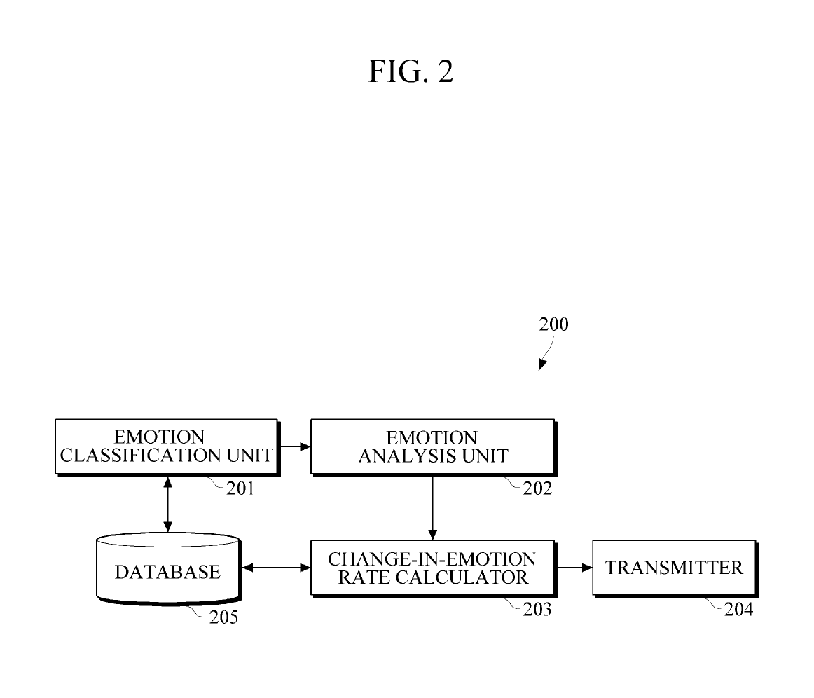

FIG. 2 is a diagram illustrating an example of a terminal 200 that may be a client terminal. Referring to FIG. 2, the terminal 200 may include an emotion classification unit 201, an emotion analysis unit 202, a change-in-emotion rate calculator 203, and a transmitter 204.

The emotion classification unit 201 recognizes a user's emotion. A method by which the emotion classification unit 201 recognizes the user's emotion is not limited to any particular technique. For example, the emotion classification unit 201 may recognize the user's emotion (for example, happiness, surprise, anger, disgust, sadness, fear, etc.) by the user's facial expression, the user's voice, the user's physiological signal, such as skin conductance level or blood pressure, the user's gesture/action, a keyboard input pattern, the kind of an application currently being executed, etc. Furthermore, the kinds or number of recognizable emotions may be varied according to an emotion recognition technique. As indicated above, various techniques for recognizing a user's emotion are well known to one of ordinary skill in the art, and thus will not be described in detail here.

The emotion classification unit 201 classifies the recognized user's emotion into one of at least two emotional states. For example, the emotion classification unit 201 may classify the recognized user's emotion into one of a positive emotional state and a negative emotional state. For example, the emotion classification unit 201 may classify an emotion, such as happiness, pleasure, romance, etc., into the positive emotional state, and an emotion, such as irritation, anxiety, sadness, etc., into the negative emotional state. Criteria for classification may be variously defined. Besides, the positive and negative emotional states are only examples, and emotions may be classified into three emotional states such as positive/neutral/negative, or into four or more emotional states based on predetermined criteria.

The emotion analysis unit 202 calculates an emotion rate. The emotion rate may be a ratio of classified emotional states. For example, if emotions are classified into positive and negative emotional states, a ratio of the number of emotions classified into the positive emotional state to the number of emotions classified into the negative emotional state may be an emotion rate. Alternatively, a ratio of the number of emotions classified into the negative emotional state to the number of emotions classified into the positive emotional state may be an emotion rate.

Also, the emotion analysis unit 202 calculates a total emotion rate and a recent emotion rate (for example, an emotion rate at a current time or at a specific time). The total emotion rate may represent an emotion rate corresponding to a total use time duration t of a terminal from the beginning of emotion recognition to a current time, and the recent emotion rate may represent an emotion rate corresponding to a specific time duration t′ ending at the current time. For example, the specific time duration may be the last 24 hours.

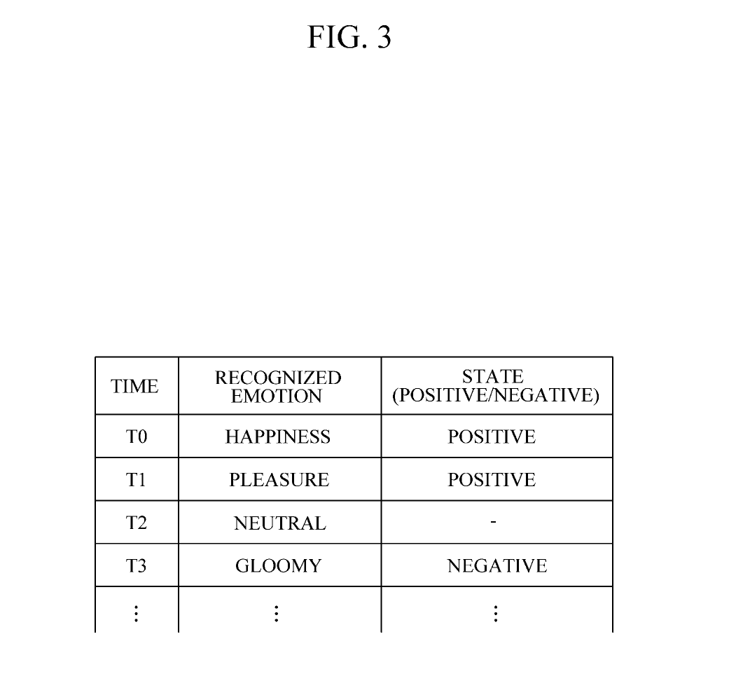

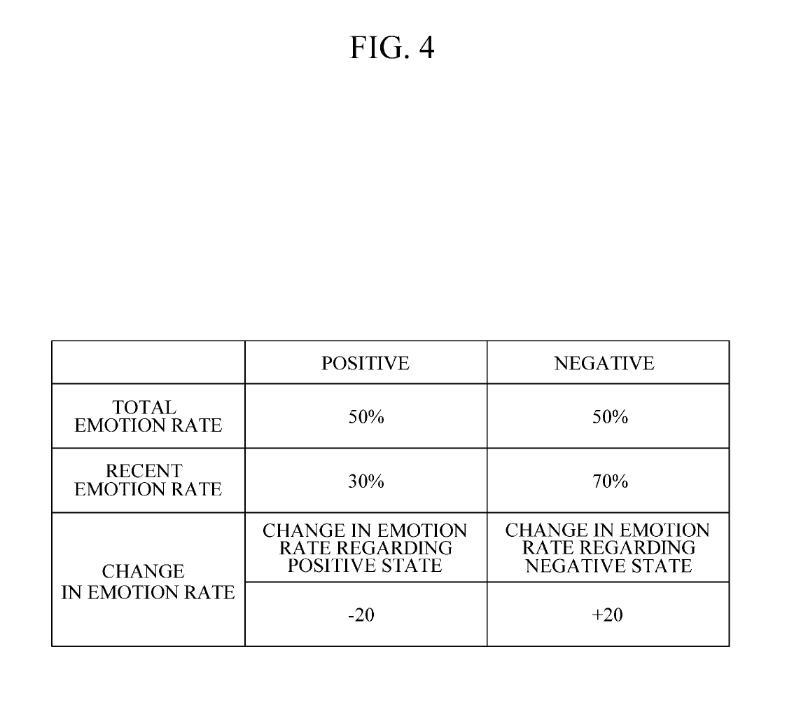

The change-in-emotion rate calculator 203 calculates a change in emotion rate using the emotion rates obtained from the emotion analysis unit 202. The change in emotion rate may include at least one of a change in emotion rate regarding the positive emotional state and a change in emotion rate regarding the negative emotional state. For example, if it is assumed that a certain person has changed from an emotion rate of 5:5 (positive versus negative) to an emotion rate of 3:7, a change in emotion rate regarding the positive emotional state is −2 and a change in emotion rate regarding the negative emotional state is +2. This will be described in more detail with reference to FIGS. 3 and 4 below.

FIG. 3 is a table for explaining an example of an emotion classification method. Referring to FIG. 3, the emotion classification unit 201 (see FIG. 2) recognizes an emotion of a user at regular intervals and classifies the recognized emotion according to predetermined criteria to thereby create a database.

For example, since an emotion recognized at a time T0 is “happiness”, the emotion classification unit 201 classifies the emotion “happiness” into the positive emotional state and creates a first data row. Since an emotion recognized at a time T1 is “pleasure”, the emotion classification unit 201 classifies the emotion “pleasure” into the positive emotional state and creates a second data row. Since an emotion recognized at a time T2 is “neutral”, which is neither a positive emotion nor a negative emotion, the emotion classification unit 201 does not classify the emotion “neutral” into either the positive emotional state or the negative emotional state, and creates a third data row. Since an emotion recognized at a time T3 is “gloomy”, the emotion classification unit 201 classifies the emotion “gloomy” into the negative emotional state and creates a fourth data row.

FIG. 4 is a table for explaining an emotion analysis method and a method of obtaining a change in emotion rate. While the emotion classification unit 201 classifies an emotion as described above with reference to FIG. 3, the emotion analysis unit 202 (see FIG. 2) calculates a total emotion rate and a recent emotion rate. For example, if a user who used to be in a neutral emotion has often experience the feeling of irritation or anger recently, the emotion analysis unit 202 calculates the total emotion rate as 50%:50% (positive versus negative) and the recent emotion rate as 30%:70% (positive versus negative).

After the total emotion rate and the recent emotion rate are calculated, the change-in-emotion rate calculator 203 (see FIG. 2) calculates a change in emotion rate based on a difference between the recent emotion rate and the total emotion rate. For example, the change-in-emotion rate calculator 203 calculates −20 (from 30%-50%) as a change in emotion rate regarding the positive emotional state and +20 (from 70%-50%) as a change in emotion rate regarding the negative emotional state. The changes in emotion rates may indicate that the corresponding user's emotional state has changed from a positive or neutral mood to a negative mood.

Referring again to FIG. 2, the transmitter 204 transmits the changes in emotion rate to other terminals. The changes in emotion rate may be either one or both of a change in emotion rate regarding the positive emotional state and a change in emotion rate regarding the negative emotional state. The changes in emotion rate may the changes in emotion weight multiplied by respective weights if the change-in-emotion rate calculator 203 has allocated respective weights to the changes in emotion rates as discussed above in the description of the change-in-emotion rate calculator 203.

According to another aspect, the change-in-emotion rate calculator 203 may allocate weights to the changes in emotion rate in consideration of the corresponding user's tendencies. For example, if the user has an outgoing or optimistic personality, the change-in-emotion rate calculator 203 may allocate a weight greater than 1 to the change in emotion rate regarding the positive emotional state and a weight smaller than 1 to the change in emotion rate regarding the negative emotional state. On the contrary, if the user has an introspective or pessimistic personality, the change-in-emotion rate calculator 203 may allocate a weight smaller than 1 to the change in emotion rate regarding the positive emotional state and a weight greater than 1 to the change in emotion rate regarding the negative emotional state. The change-in-emotion rate calculator 203 may then multiply the change in emotion rate regarding the positive emotional state and the change in emotion rate regarding the negative emotional state by their respective weights.

According to another aspect, the terminal 200 may further include a database 205. The database 205 may store the corresponding user's tendencies, information regarding weights that are to be allocated according to the user's tendencies, various emotion models by which the emotion classification unit 201 recognizes the user's emotions, emotion classification criteria that are to be used by the emotion classification unit 201, results of the emotion classification, etc.

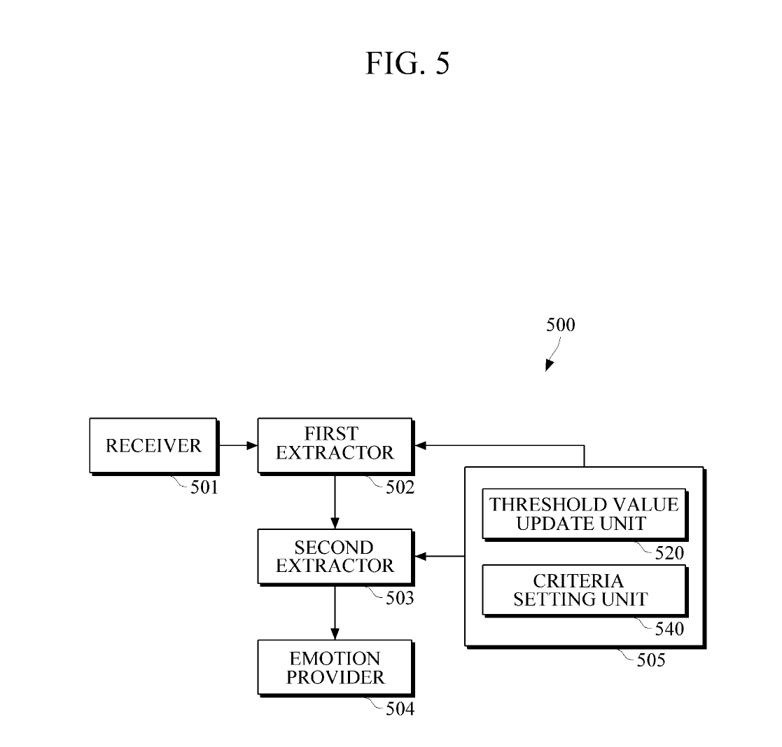

FIG. 5 is a diagram illustrating an example of a terminal 500 that may be a server terminal. Referring to FIG. 5, the terminal 500 includes a receiver 501, a first extractor 502, a second extractor 503, and an emotion provider 504.

The receiver 501 receives changes in individual users' emotion rates from a plurality of terminals. The changes in individual users' emotion rates have been described above with reference to FIGS. 2 and 4. That is, each change in emotion rate, received by the receiver 501, may be at least one of a change in emotion rate regarding a positive emotional state and a change in emotion rate regarding a negative emotional state if a user's emotion is represented as a ratio of the positive emotional state to the negative emotional state.

The first extractor 502 extracts an emotion transmitting terminal from the terminals that have sent the changes in emotion rate. The emotion transmitting terminal may be a terminal having a great change in emotion rate. The emotion transmitting terminal may be determined according to the results of comparisons between the received changes in emotion rate and a predetermined threshold value. A change in emotion rate that exceeds the predetermined threshold value may be considered to be a great change in emotion rate. For example, the first extractor 502 may extract a user's terminal having a change in emotion rate that exceeds the predetermined threshold value as an emotion transmitting terminal. This may represent that the corresponding user is in a very gloomy mood.

The second extractor 503 extracts all or a part of terminals registered in the emotion transmitting terminal as emotion receiving terminals. For example, the second extractor 503 may extract emotion receiving terminals based on a list of acquaintances registered in the emotion transmitting terminal.

The emotion provider 504 transmits the user emotion information of the emotion transmitting terminal to the emotion receiving terminals. For example, the emotion provider 504 may inform the user's acquaintances that the user is presently in a very gloomy mood.

According to another aspect, the terminal 500 may further include a setting unit 505. The setting unit 505 may include a threshold value update unit 520 and a criteria setting unit 540.

The threshold value update unit 520 may update the predetermined threshold value of the first extractor 502 based on a change in emotion rate received after the user's emotional state is provided by the emotion provider 504. For example, when the user's emotional state is not improved even after the user's acquaintances have been informed of the user's emotional state, the threshold value update unit 520 may increase or decrease the threshold value of the first extractor 502.

The criteria setting unit 540 may set a range of emotion receiving terminals that are extracted by the second extractor 503. For example, when the second extractor 503 extracts emotion receiving terminals from terminals registered in the emotion transmitting terminal, the second extractor 503 may extract emotion receiving terminals in a predetermined sharing range that has been set by the criteria setting unit 540. The predetermined sharing range may be determined by the current location of the emotion transmitting terminal or a contact frequency stored in the emotion transmitting terminal, or may be set directly by a user of the emotion transmitting terminal.

According to another aspect, before providing the user's emotional state to each emotion receiving terminal, the emotion provider 504 may query the emotion transmitting terminal about whether or not to transmit the user's emotional state to the emotion receiving terminal. If the emotion transmitting terminal disallows transmission of the user's emotional state to one or more of the emotion receiving terminals, the emotion provider 504 may exclude the corresponding emotion receiving terminal or terminals from the emotion receiving terminals, and the criteria setting unit 504 may reflect information about the excluded emotion receiving terminals to the criteria by which the second extractor 503 extracts emotion receiving terminals.

In FIGS. 2 and 5, each functional block may be implemented in the form of an electrical circuit and/or hardware that is installed in a terminal, in the form of a module of a processor included or installed in a terminal, or in the form of an application program. Also, the functional blocks shown in FIGS. 2 and 5 are only conceptually divided for convenience of explanation, and the functions of the terminal 200 or 500 may be classified according to other criteria. That is, the functional units may be implemented as a single integrated unit or implement as two or more separate units. Furthermore, a part of functions that are performed by one functional unit may be performed by one or more other functional units.

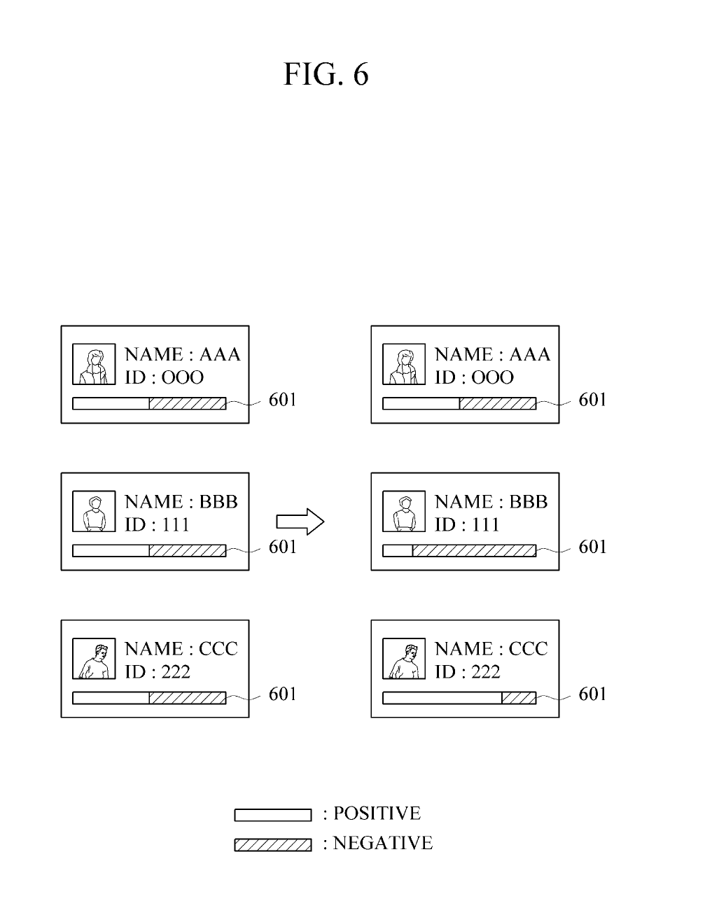

FIG. 6 is a view for explaining an example of a method of providing an emotional state. Referring to FIG. 6, contact cards 601 may be a list of acquaintances displayed on a screen of an emotion receiving terminal. An emotion receiving terminal that has received a user's emotional state may represent a positive/negative emotional state through an emotion state bar displayed on a contact card corresponding to the user. For example, in the current example, it is seen that a negative emotional state of a user “BBB” greatly has greatly increased, and a positive emotional state of a user “CCC” has greatly increased. Accordingly, a user of the emotion receiving terminal may contact the user “BBB” to empathize and help him or her recover from his or her negative mood. Also, the user of the emotion receiving terminal may contact the user “CCC” whose emotion has greatly changed to a positive emotional state to empathize and share his or her positive mood.

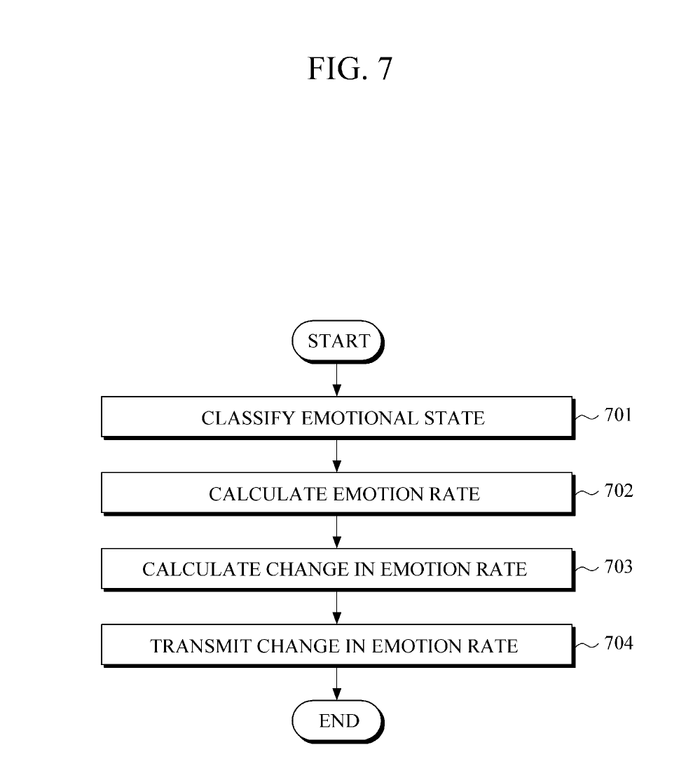

FIG. 7 is a flowchart illustrating an example of an emotion sharing method. The emotion sharing method may be an example of a process that is executed by a client terminal (for example, one of the terminals T#0 through T#7 shown in FIG. 7). Thus, the description of operation of the client terminal 200 in FIG. 2 is also applicable to the method of FIG. 7, and will not be repeated here.

Referring to FIGS. 2 and 7, first, a recognized emotion is classified into one of a positive emotional state and a negative emotional state (701). For example, the emotion classification unit 201 may classify a recognized emotion into one of a positive emotional state and a negative emotional state according to predetermined criteria as shown in the table of FIG. 3.

Then, an emotion rate is calculated (702). The emotion rate may be a percentage of the number of positive emotional states with respect to the number of negative emotional states. For example, the emotion analysis unit 202 may calculate a total emotion rate and a recent emotion rate.

Next, a change in emotion rate is calculated (703). For example, the change-in-emotion rate calculator 203 may calculate a change in emotion rate regarding a positive emotional state and a change in emotion rate regarding a negative emotional state by subtracting the total emotion rate from the recent emotion rate.

Then, the change in emotion rate is transmitted (704). For example, the transmitter 204 may transmit the change in emotion rate to a server terminal (for example, the terminal T#0 of FIG. 1).

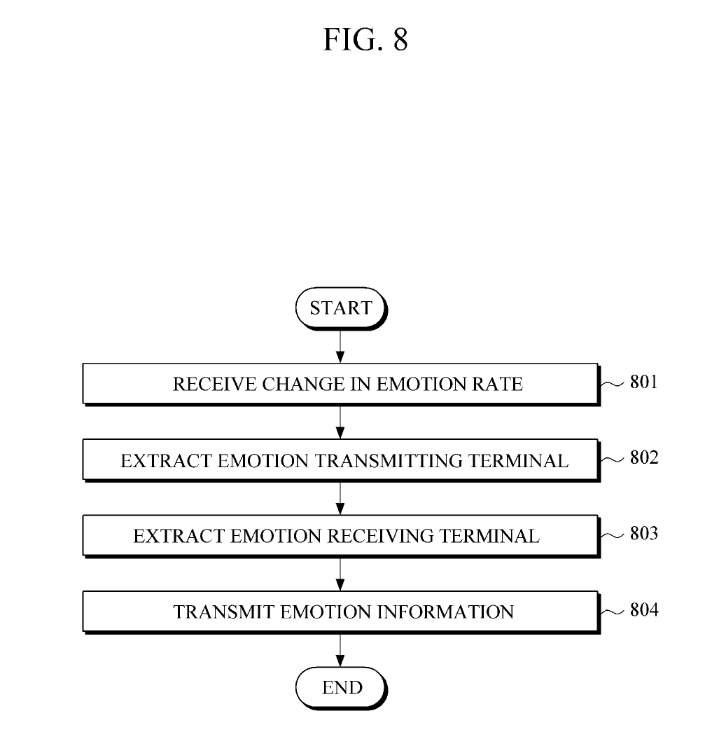

FIG. 8 is a flowchart illustrating an example of an emotion sharing method. The emotion sharing method may be an example of a process that is executed by a server terminal (for example, the terminal T#0 of FIG. 1). Thus, the description of operation of the server terminal 500 in FIG. 5 is also applicable to the method of FIG. 8, and will not be repeated here.

Referring to FIGS. 5 and 8, a change in emotion rate is received (801). For example, the receiver 501 may receive a change (in the example of FIG. 4, −20) in emotion rate regarding the positive emotional state.

Then, an emotion transmitting terminal is extracted (802). For example, the first extractor 502 may extract a terminal having a change in emotion rate that exceeds a predetermined threshold value, and thus may be considered to be a great change in emotion rate, as an emotion transmitting terminal.

Next, an emotion receiving terminal is extracted (803). For example, the second extractor 503 may extract all or a part of terminals registered in the emotion transmitting terminal as emotion receiving terminals according to predetermined criteria.

Then, an emotional state of the user of the emotion transmitting terminal is transmitted to the emotion receiving terminals. For example, the emotion provider 504 may transmit the user's change in emotion rate to his or her acquaintances.

Therefore, according to the examples described above, each client terminal transmits information about the corresponding user's change in emotional state to a server terminal, and the server terminal detects a user having a great change in emotional state and transmits the detected emotional state of the user to the user's acquaintances, thereby enabling various interactions based on shared emotional states. Particularly, a user who is in a negative emotional state may be helped to recover from his or her negative emotional state through various interactions between users, and a user who is in a positive emotional state may share his or her positive mood with other users.

The various methods described above may be performed using hardware components and/or software components. The various elements in FIGS. 2 and 5 may be implemented using hardware and/or software components. Software components may be implemented by a processing device, which may be implemented using one or more general-purpose or special-purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purposes of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such a parallel processors.

As used herein, a processing device configured to implement a function A includes a processor programmed to run specific software. In addition, a processing device configured to implement a function A, a function B, and a function C may include configurations, such as, for example, a processor configured to implement functions A, B, and C; a first processor configured to implement function A and a second processor configured to implement functions B and C; a first processor configured to implement functions A and B and a second processor configured to implement function C; a first processor to implement function A, a second processor configured to implement function B, and a third processor configured to implement function C; a first processor configured to implement functions A, B, C and a second processor configured to implement functions A, B, and C, and so on.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion.

In particular, the software and data may be stored by one or more non-transitory computer-readable storage mediums. The non-transitory computer-readable storage medium may include any data storage device that can store data that can be thereafter read by a computer system or processing device. Examples of a non-transitory computer-readable storage medium include read-only memory (ROM), random-access memory (RAM), CD-ROMs, magnetic tapes, floppy disks, and optical data storage devices. Also, functional programs, codes, and code segments for implementing the examples disclosed herein can be easily constructed by programmers skilled in the art to which the examples pertain based on the drawings and their corresponding descriptions as provided herein.

While the invention has been particularly shown and described with reference to several examples thereof, it will be understood by one of ordinary skill in the art that various modifications may be made in these examples without departing from the spirit and scope of the invention as defined by the claims and their equivalents. For example, suitable results may be achieved if the described techniques are performed in a different order and/or if components in a described system, architecture, device, or circuit are combined in a different manner and/or replaced and/or supplemented by other components or their equivalents. Therefore, the scope of the invention is defined not by the detailed description of the disclosure, but by the claims and their equivalents, and all variations within the scope of the claims and their equivalents are to be construed as being included in the invention.

What is claimed is:

1. An emotion sharing apparatus comprising:
an emotion classification unit configured to classify a recognized emotional state of a user of a terminal into one of at least two kinds of emotional states;
an emotion analysis unit configured to calculate an emotion rate defined based on a ratio of one kind of emotional state of the at least two kinds of emotional states to another kind of emotional state of the at least two kinds of emotional states;
a change-in-emotion rate calculator configured to calculate a change in the emotion rate; and
a transmitter configured to transmit the change in the emotion rate to another terminal.

2. The emotion sharing apparatus of claim 1, wherein the at least two kinds of emotional states comprise a positive emotional state and a negative emotional state.

3. The emotion sharing apparatus of claim 2, wherein the emotion analysis unit is further configured to calculate the emotion rate based on a ratio of the positive emotional state to the negative emotional state.

4. The emotion sharing apparatus of claim 1, wherein the emotion analysis unit is further configured to calculate a total emotion rate and a recent emotion rate according to a use time of the terminal of the user.

5. The emotion sharing apparatus of claim 4, wherein the change-in-emotion rate calculator is further configured to calculate the change in the emotion rate based on a difference between the recent emotion rate and the total emotion rate.

6. The emotion sharing apparatus of claim 1, wherein the change-in-emotion rate calculator is further configured to allocate a weight to the change in the emotion rate in consideration of a tendency of the user.

7. An emotion sharing apparatus comprising:
a receiver configured to receive a change in an emotion rate for each of a plurality of users from a plurality of terminals respectively used by the users;
a first extractor configured to extract an emotion transmitting terminal from the plurality of terminals based on the change in the emotion rate for each of the users;
a second extractor configured to extract at least one emotion receiving terminal from at least one terminal registered in the emotion transmitting terminal; and
an emotion provider configured to transmit information about an emotional state of the user of the emotion transmitting terminal to the at least one emotion receiving terminal.

8. The emotion sharing apparatus of claim 7, wherein an emotion of the user is classified into one of at least two kinds of emotional states; and
the change in the emotion rate is defined based on a ratio of one kind of emotional state of the at least two kinds of emotional states to another kind of emotional state of the at least two kinds of emotional states.

9. The emotion sharing apparatus of claim 7, wherein an emotion rate of the user is represented as a ratio of a positive emotional state to a negative emotional state; and
the change in the emotion rate comprises at least one of a change in an emotion rate regarding the positive emotional state and a change in an emotion rate regarding the negative emotional state.

10. The emotion sharing apparatus of claim 9, wherein the first extractor is further configured to extract, as the emotion transmitting terminal, a terminal of a user having a change in an emotion rate that exceeds a predetermined threshold value.

11. The emotion sharing apparatus of claim 10, further comprising a threshold value update unit configured to update the predetermined threshold value according to a change in an emotion rate received by the receiver after the emotional state of the user has been transmitted to the at least one emotion receiving terminal by the emotion provider.

12. The emotion sharing apparatus of claim 7, wherein the second extractor is further configured to extract, as the at least one emotion receiving terminal, at least one terminal in a predetermined sharing range in the at least one terminal registered in the emotion transmitting terminal.

13. The emotion sharing apparatus of claim 12, wherein the predetermined sharing range is determined by a current location of the emotion transmitting terminal or a contact frequency stored in the emotion transmitting terminal, or is set by the user of the emotion transmitting terminal.

14. The emotion sharing apparatus of claim 7, wherein the emotion provider is further configured to query the emotion transmitting terminal about whether or not to provide the emotional state of the user to the at least one emotion receiving terminal before transmitting the emotional state of the user to the at least one emotion receiving terminal.

15. An emotion sharing system comprising:
a plurality of client terminals each configured to:
classify a recognized emotional state of a user of the client terminal into a positive emotional state and a negative emotional state;
calculate an emotion rate defined based on a ratio of the positive emotional state to the negative emotional state;
calculate a change in the emotion rate; and
transmit the change in the emotion rate to other ones of the client terminals; and
a server terminal configured to:
receive a change in an emotion rate for each user of the plurality of client terminals from the plurality of client terminals;
extract an emotion transmitting terminal from the plurality of client terminals based on the change in the emotion rate for each user;
extract at least one emotion receiving terminal from at least one client terminal registered in the emotion transmitting terminal; and
transmit information about an emotional state of the user of the emotion transmitting terminal to the at least one emotion receiving terminal.

16. An emotion sharing method comprising:
classifying a recognized emotional state of a user of a terminal into one of at least two kinds of emotional states;
calculating an emotion rate defined based on a ratio of one kind of emotional state of the at least two kinds of emotional states to another kind of emotional state of the at least two kinds of emotional states;
calculating a change in the emotion rate; and
transmitting the change in the emotion rate to another terminal.

17. A non-transitory computer-readable storage medium storing instructions for controlling a processor to perform the emotion sharing method of claim 16.

18. An emotion sharing method comprising:
receiving a change in an emotion rate for each user of a plurality of users from a plurality of terminals respectively used by the users;
extracting an emotion transmitting terminal from the plurality of terminals based on the change in the emotion rate for each of the users;
extracting at least one emotion receiving terminal from at least one terminal registered in the emotion transmitting terminal; and
transmitting information about an emotional state of the user of the emotion transmitting terminal to the at least one emotion receiving terminal.

19. A non-transitory computer-readable storage medium storing instructions for controlling a processor to perform the emotion sharing method of claim 18.

20. An emotion sharing apparatus comprising:
an emotion classification unit configured to classify recognized emotional states of a user of a terminal into a plurality of kinds of emotional states;
an emotion analysis unit configured to calculate an emotion rate based on a ratio of a number of the emotional states that have been classified into a first kind of the plurality of kinds of emotional states to a number of the emotional states that have been classified into a second kind of the plurality of kinds of emotional states;
a change-in-emotion rate calculator configured to calculate a change in the emotion rate; and
an emotion provider configured to transmit the change in the emotion rate to another terminal used by another user.

21. The emotion sharing apparatus of claim 20, wherein the emotion analysis unit is further configured to calculate:
a total emotion rate for a total period of time from a beginning of emotion recognition for the user to a current time; and
a recent emotion rate for a specific period of time ending at the current time.

22. The emotion sharing apparatus of claim 21, wherein the change-in-emotion rate calculator is further configured to calculate the change in the emotion rate based on a difference between recent emotion rate and the total emotion rate.

23. The emotion sharing apparatus of claim 22, wherein the change-in-emotion rate calculator is further configured to calculate:
a first change in emotion rate for the first kind of emotional state based on the difference between the recent emotion rate and the total emotion rate; and
a second change in emotion rate for the second kind of emotional state based on the difference between the recent emotion rate and the total emotion rate.

24. The emotion sharing apparatus of claim 23, wherein the change-in-emotion rate calculator is further configured to:
multiply the first change in emotion rate by a first weight to obtain a first weighted change in emotion rate; and
multiply the second change in emotion rate by a second weight to obtain a second weighted change in emotion rate; and
the emotion provider is further configured to transmit the first weighted change in emotion rate and the second weighted change in emotion rate to the other terminal.
